(19) United States
(12) Patent Application Publication
(10) Pub. No.: US 2026/0300310 A1
(43) Pub. Date: Oct. 1, 2026

(54) SYSTEM AND METHOD FOR EVENT-DRIVEN, MULTI-PLAYER NOTE CAPTURE, DASHBOARD PROGRESS TRACKING, AND AUTOMATED SUMMARIZATION IN SPORTS SCOUTING

(71) Applicant: Peter Picerelli, Austin, TX (US)

(72) Inventor: Peter Picerelli, Austin, TX (US)

(21) Appl. No.: 19/172,895

(22) Filed: Apr. 8, 2025

Related U.S. Application Data
(60) Provisional application No. 63/780,292, filed on Mar. 29, 2025.

(51) Int. Cl. G06F 16/25; G06F 16/248; G06F 40/174; G06F 40/186; G06F 40/40

(52) U.S. Cl. CPC G06F 16/25; G06F 16/248; G06F 40/174; G06F 40/186; G06F 40/40

(57) ABSTRACT

A system and method for real-time scouting data capture, metadata tagging, bundling, and LLM-based summarization. The invention automates evaluation report generation, improves standardization, and reduces latency through structured workflows and hybrid storage architectures.

### CROSS-REFERENCE TO RELATED APPLICATIONS

This application claims priority to U.S. Provisional Patent Application No. 63/780,292 filed Mar. 29, 2025, titled “SYSTEM AND METHOD FOR EVENT-DRIVEN, MULTI-PLAYER NOTE CAPTURE, DASHBOARD PROGRESS TRACKING, AND AUTOMATED SUMMARIZATION IN SPORTS SCOUTING”.

### BACKGROUND

The present invention relates generally to data capture and workflow automation systems, and more specifically to systems and methods for real-time note capture, metadata tagging, report generation, and evaluation tracking in the context of sports scouting, enabled by artificial intelligence and large language models to improve latency, consistency, and organizational compliance in sports evaluation workflows.

### Technical Limitations in Current Scouting Technologies

Unstructured Note-Taking Applications Applications such as Microsoft OneNote and Evernote lack:
Schema-flexible support for many-to-many relationships between observations and players.
Automated contextual metadata tagging (e.g., source role, timestamp, device, spatial attributes).
Real-time concurrency and synchronization across multiple devices and users.
Direct integration with proprietary or organizational APIs.
AI-driven summarization for generating standardized evaluation reports.
Spreadsheet and Database Solutions Tools like Microsoft Excel and SQL-based databases struggle with:
Rigid schemas incompatible with narrative scouting data.
Poor user experience in collaborative environments.
Limited capabilities in multi-entity note association.
Inconsistent data validation across inputs.
Sports Analytics Platforms Systems such as Hudl or Catapult are optimized for quantitative tracking but lack:
Narrative and qualitative input support.
Source attribution for observed behaviors.
LLM-integrated workflows for evaluation summarization.
General-Purpose AI Tools Tools like Otter.ai lack:
Sports-specific semantic understanding.
Contextual multi-player note disambiguation.
Template-bound generation models that meet internal standards.
Integration into proprietary scouting pipelines.
Technical Challenges Addressed The disclosed invention resolves the above limitations via:
Dynamic entity-relationship modeling for player-observation-event-source linkage, preserving contextual provenance across all note-taking and evaluation processes.
Real-time, concurrent note entry with automated metadata generation, supporting multi-entity association and contextual tagging.
A prompt selection engine that computes a relevance score by matching a weighted vector of scouting context attributes—such as source role, player position, and evaluation purpose—against stored template metadata.
An LLM pipeline configured for evaluation-specific output formatting with organization-standard constraints, including template alignment and grammar validation.
A hybrid data architecture capable of managing unstructured narrative data and structured evaluation records, enabling fast retrieval, cross-linking, and version control.
Workflow-triggered processing to reduce latency between note entry and dashboard-visible evaluations, using publish-subscribe messaging for real-time updates.

### SUMMARY OF INVENTION

Therefore, the present invention provides a system and method for capturing, bundling, processing, and presenting scouting evaluations via:

A real-time, multi-player note capture interface with source-aware tagging.

A context-aware LLM summarization pipeline utilizing weighted prompt template scoring.

Hybrid data storage and version-controlled evaluation management.

Dynamic dashboards with publish-subscribe synchronization.

Metadata-driven automation and organizational compliance enforcement.

The system programmatically eliminates manual report synthesis latency by transforming fragmented, narrative input into standardized evaluations while maintaining stylistic and structural consistency across reports.

### BRIEF DESCRIPTION OF THE DRAWINGS

FIG. 1—System Architecture Overview

FIG. 2—Process Flow Diagram

FIG. 3—Dashboard System Architecture

FIG. 4—School and Source Selection UI

FIG. 5—Smart Notebook Multi-Player Note Entry Interface

FIG. 6—Evaluation Dashboard and Completion Visualization

FIG. 7—Data Lifecycle Workflow with Player Profile & Dashboard Outputs

### DETAILED DESCRIPTION

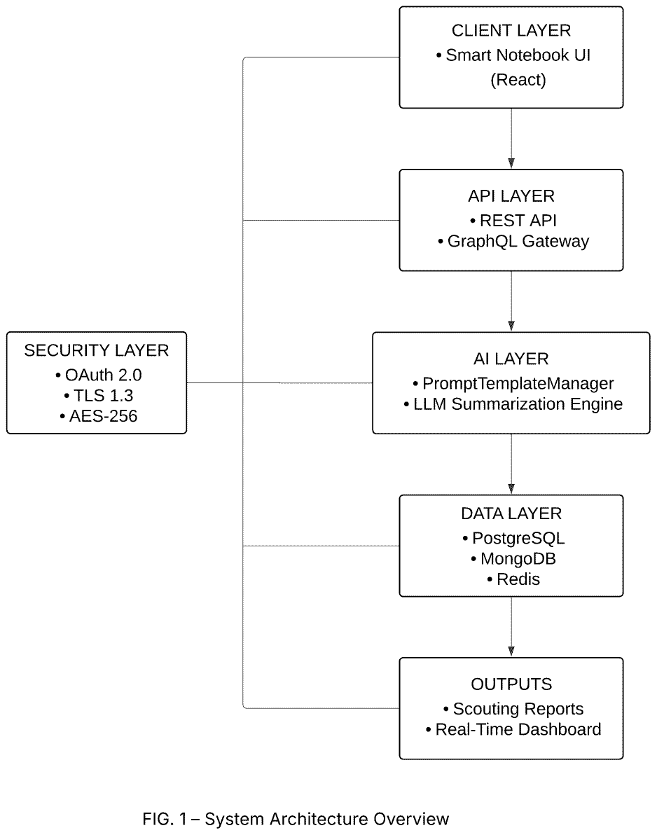

FIG. 1—System Architecture Overview This figure presents the multi-layered architecture of the system, including the client layer (React UI), API layer (REST and GraphQL services), data layer (PostgreSQL, MongoDB, Redis), AI layer (PromptTemplateManager and LLM Engine), and security layer (OAuth 2.0, TLS 1.3, AES-256). It depicts the directional flow of data across these components, highlighting their interdependence and communication pipelines for managing note capture, tagging, processing, and dashboard display.

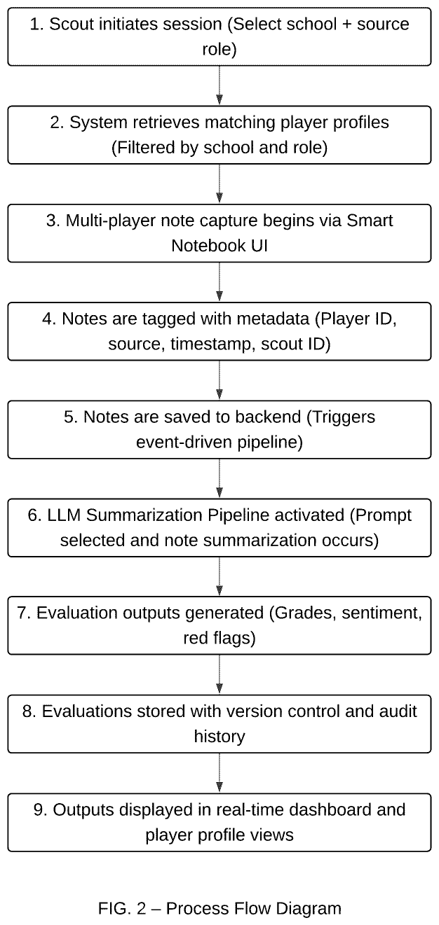

FIG. 2—Process Flow Diagram This figure illustrates steps 1-9 of the flow of a scout's interaction with the system, beginning with session initiation and source selection, continuing through note capture and metadata tagging, and culminating in LLM-based summarization and dashboard output. It shows how each action is event-triggered and data is routed through each component in sequence.

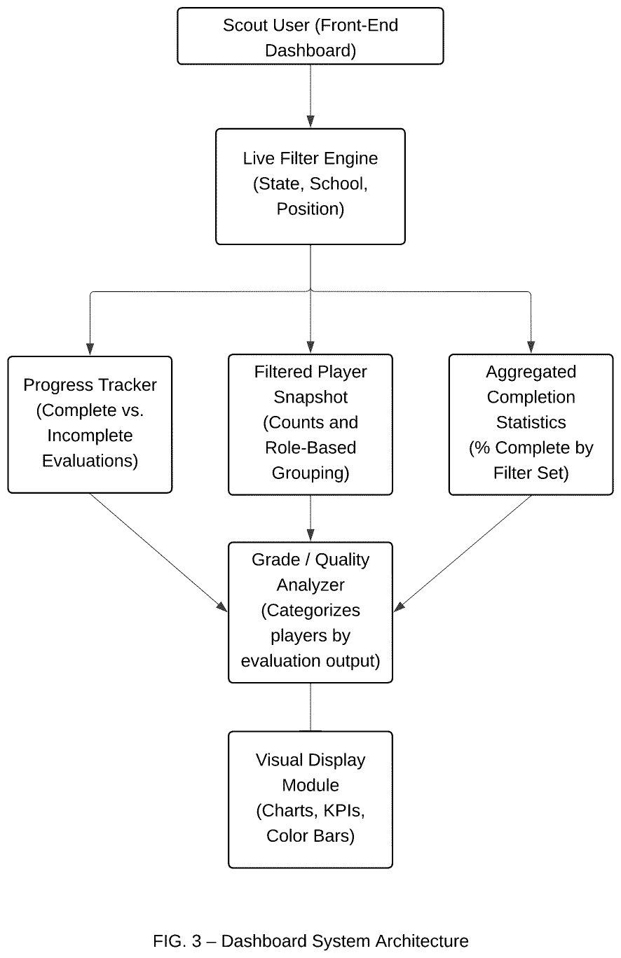

FIG. 3—Dashboard System Architecture This figure outlines the internal architecture of the dashboard layer, including filtering logic, evaluation status tracking, subscription-based WebSocket messaging, and frontend rendering components. It visualizes how scouts, directors, and other user roles receive filtered, real-time evaluation data.

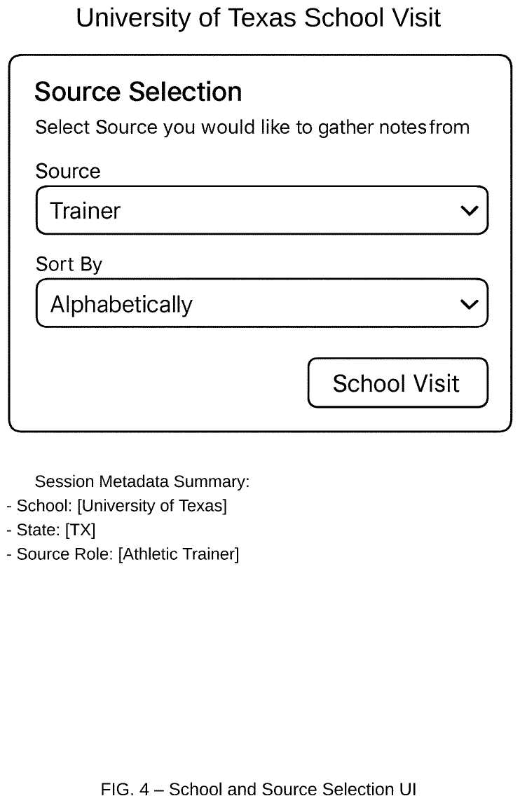

FIG. 4—School and Source Selection UI This figure depicts the scout-facing interface used to initiate a new evaluation session. It includes dropdown selectors for school, category, state, and source role. It serves as the entry point for tying metadata to a Smart Notebook session and initiating role-aware workflows.

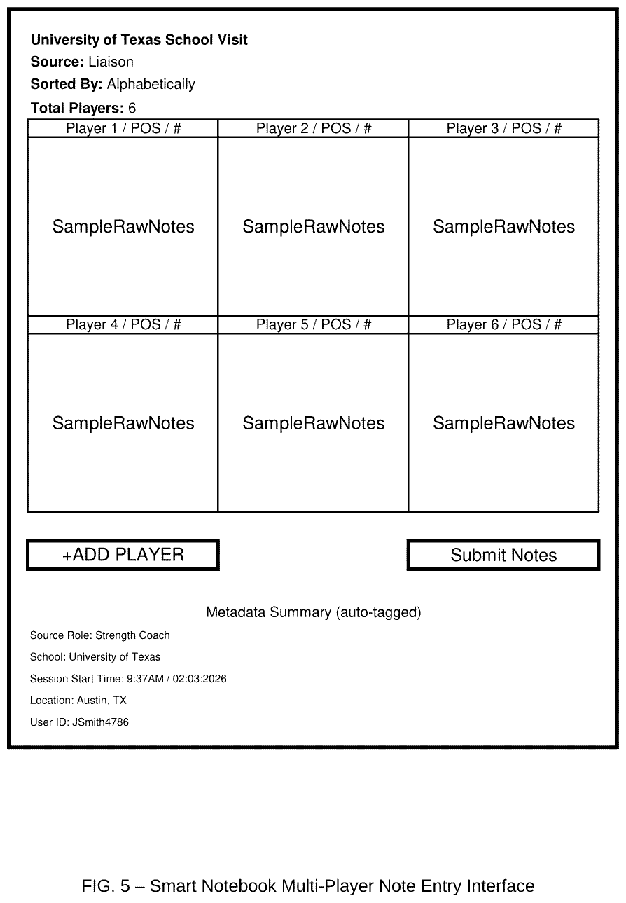

FIG. 5—Smart Notebook Multi-Player Note Entry Interface This figure shows the real-time note entry interface, supporting simultaneous observations of multiple players. Notes are captured via text input and linked dynamically to player IDs, source roles, and other session metadata.

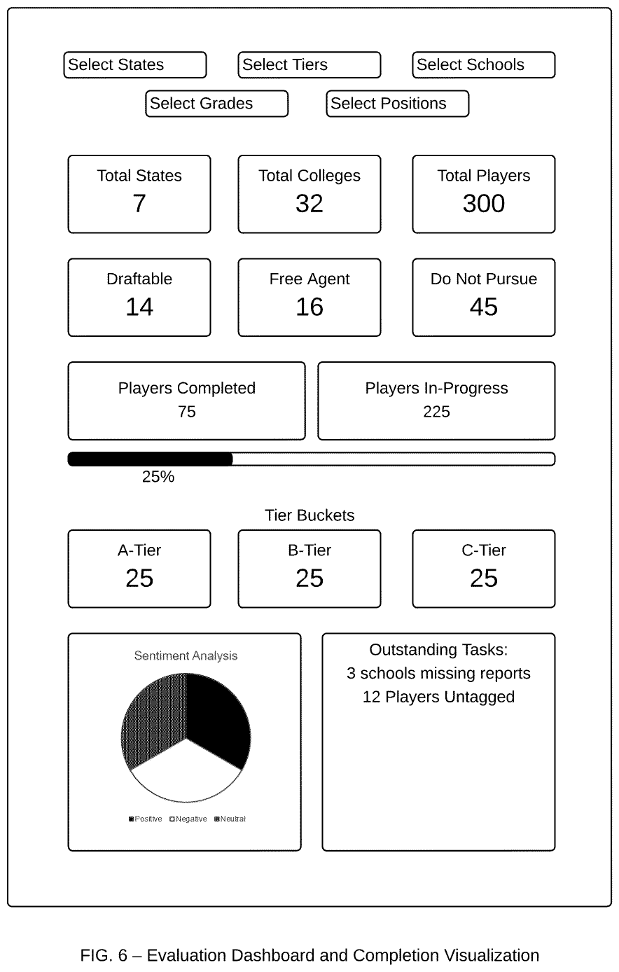

FIG. 6—Evaluation Dashboard and Completion Visualization This figure displays the dashboard view showing evaluation progress by scout, region, school, and player. It includes visualizations such as completion bars, tier buckets, sentiment graphs, and outstanding task alerts, enabling upper management to monitor real-time evaluation health.

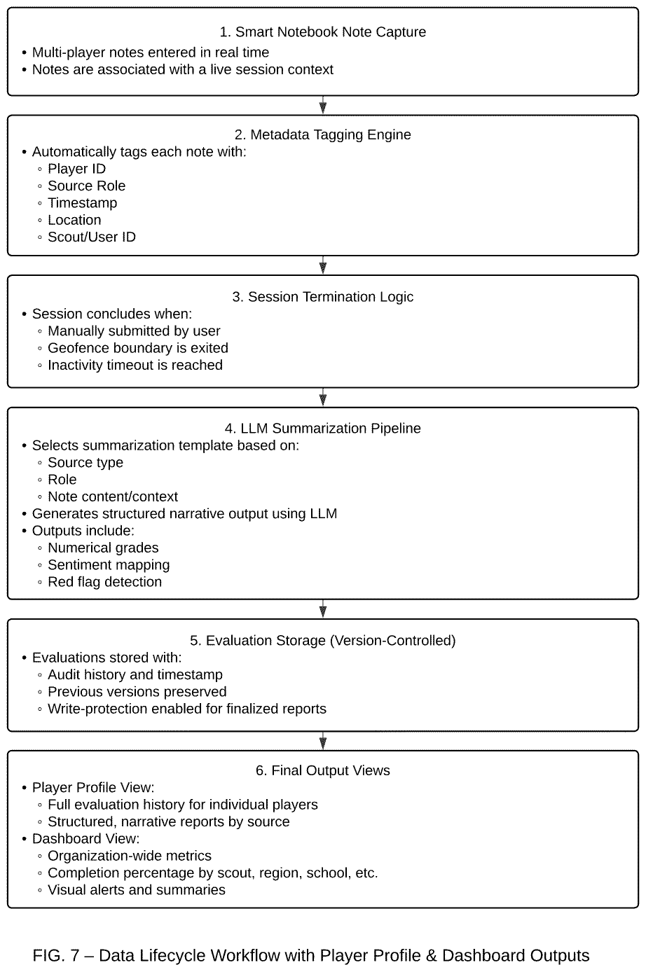

FIG. 7—Data Lifecycle Workflow with Player Profile & Dashboard Outputs This figure illustrates the end-to-end lifecycle of scouting data within the system, from initial entry to final structured output. It demonstrates the technical sequence of operations that transforms raw, multi-entity observations into standardized, organization-aligned reports viewable within both the dashboard and individual player profiles.

The figure begins with a Smart Notebook session where multi-player notes are captured and tagged in real time. These tagged notes are automatically processed by the Metadata Tagging Engine, which stores contextual attributes and links to structured entities. Upon session termination—detected via manual submission, geofencing, or inactivity—the system bundles notes by player ID and routes them through the LLM Summarization Pipeline.

The pipeline selects a template based on contextual relevance and constructs a prompt to generate structured narrative evaluations, including numerical grading, red flags, and sentiment mapping. The resulting evaluations are stored with version control metadata and rendered in two views: the Player Profile View (detailed history per player) and the Dashboard View (organization-wide metrics and completion status).

This system is not a generic application of AI or note capture. It introduces a structured, event-driven workflow that transforms informal, multi-entity observations into standardized outputs via a technically specific pipeline. Each subsystem—note tagging, template scoring, metadata routing, and dashboard rendering—contributes to reducing latency and cognitive load while improving consistency. The claimed invention is non-obvious due to the domain-specific nature of the problem, the contextual prompt scoring logic, and the real-time, metadata-aware orchestration of summarization workflows. All architectural components are described in sufficient technical detail to enable replication by a person of ordinary skill in the art.

### 7.1 User Interface Layer

Built using JavaScript frameworks (e.g., React or Vue), this UI allows school/source selection and concurrent notetaking for multiple players. It supports autosaving and completion indicators.

### 7.2 Tagging and Data Engine

Notes are associated with:
Session ID
Source Role (e.g., Head Coach, Trainer)
Player ID
Timestamp
Scout ID
These are stored in a hybrid SQL/NoSQL backend.

### 7.3 Summarization Pipeline With LLM Integration

Triggered on session closure, the system:
Bundles notes per player
Constructs structured prompts
Calls LLM for summarization, producing:
Narrative reports
Sentiment score
Trait-based grades (1-7)
Key attribute phrases

### 7.3.1 Exemplary Prompt Template for Character Evaluation Module (Non-Limiting Example)

### General Character Evaluation Prompt Template

You are a scout, coach, or evaluator responsible for generating structured character assessments for individual athletes. Each evaluation is divided into four major categories and uses a 1-5 grading scale. Each category must include specific, anecdotal evidence that supports the assigned grade. The output format must be highly structured and aligned with internal evaluation standards.

### Evaluation Scale

1—Major Concern
2—Below Expectations
3—Meets Expectations
4—Strong
5—Exceptional

### Output Format Requirements

The evaluation begins immediately with structured section headers.

Each section includes the section title and the assigned grade in parentheses (e.g., Football Character (Grade: 4)).

Under each section, provide at least two bullet points, each containing a specific anecdote, behavior, or insight that supports the grade.

Avoid vague or generic phrasing; each point must be directly tied to an observed or sourced behavior.

The final two sections (Family Dynamic & Additional Context and Health and Injury Summary) may also include paragraph-style narrative if needed for clarity.

Ensure a line break between each section for readability.

### Character Evaluation Format

Football Character (Grade: ______)
Bullet point 1
Bullet point 2
Personal Character (Grade: ______)
Bullet point 1
Bullet point 2
Family Dynamic & Additional Context (Grade: ______)
Bullet point 1 or paragraph
Bullet point 2 or paragraph
Health and Injury Summary (Grade: ______)
Bullet point 1 or paragraph
Bullet point 2 or paragraph

Note: In some implementations, the system may dynamically adapt category labels, grading scales, or formatting rules based on user role (e.g., scout, coach, or evaluator), player position, or organizational reporting requirements. This format is provided as a non-limiting example of structured prompt engineering within the disclosed system.

### 7.4 Dashboard Engine

The system includes real-time filtering by scout, region, and position group, supporting completion analytics and visual overlays. Dashboards are updated continuously via WebSocket or publish/subscribe mechanisms.

### 7.5 Version Control and Audit Logging

LLM output can be edited by users. All edits are logged with timestamps and user IDs. Revisions are tracked per summary with rollback support.

### 7.6 End-to-End Data Lifecycle and Visualization Outputs

The system supports an end-to-end scouting data lifecycle with the following stages:

### 1. Multi-Player Note Capture

Scouts initiate a session linked to a school or event. Notes entered in the Smart Notebook interface are tagged with:
Player IDs (supporting multi-targeted input)
Source role (e.g., Strength Coach)
Timestamp
Session ID

### 2. Real-Time Metadata Tagging Engine

The backend immediately:
Parses and applies metadata tags
Stores notes in a document-oriented NoSQL store
Establishes relational references to player and session records

### 3. Event-Driven Trigger on Session Termination

A backend service monitors for session closure via:
Manual “Submit” button
Inactivity timeout
UI-based “End Visit” action
Notes are then grouped by player and queued for LLM summarization.

### 4. LLM Summarization Pipeline

For each player, the system dynamically selects:
The appropriate prompt template based on source role and note structure
Organizational tone and formatting style
The LLM returns a structured output containing:
Narrative summary
Sectional breakdown (e.g., character traits)
1-7 numeric scores
Sentiment classification and red flag alerts

### 5. Version-Controlled Storage

Summaries are stored with:
Revision ID
Prompt version used
Timestamp and scout attribution
Link to the underlying source notes

### 6. Dual Output Display

Player Profile View includes:
Most recent and historical evaluations
Editable summaries with version tracking
Role-based comments and coaching feedback
Dashboard View includes:
Evaluation completion rates by scout, region, or school
Player tiering visualizations
Sentiment trends and evaluation timelines
Real-time update indicators across devices

### Example Use Case

A scout initiates a session using the Smart Notebook interface and records observations tied to multiple players in real time. Each note is contextually tagged with metadata such as source role, time, and location. Upon session completion—either manually or via an automated trigger such as geofencing or inactivity—the system dynamically groups the notes by player, routes them through a context-scored prompt selection engine, and submits them to an LLM. The returned summaries are stored with version metadata and published to both player profiles and real-time dashboards. This end-to-end process reduces average evaluation time from approximately 45 minutes to under 30 seconds per player.

### Technical Implementation Examples

Prompt Template Selection and LLM Integration (Non-Limiting Example)
def select_prompt_template(context_attributes):
   vector=generate_weighted_vector(context_attributes)
   templates=retrieve_templates( )
   scored=score_templates(templates, vector)
   return select_highest_scoring(scored)
def generate_weighted_vector(context_attributes):
   #Example context: source_role=“Trainer”, position=“DB”, eval_type=“Character”
   weights={“source_role”: 0.4, “position”: 0.3, “eval_type”: 0.3}
      return {k: weights[k]*hash(context_attributes[k]) for k in context_attributes}
def score_templates(templates, context_vector):
   scored_templates= [symbol]
   for template in templates:
      score=cosine_similarity(template.vector, context_vector)
      scored_templates.append((template.id, score))
   return scored_templates
def select_highest_scoring(scored_templates):
   return max(scored_templates, key=lambda x: x[1])[0]
12.2 Metadata Tagging Engine Logic (Non-Limiting Example)
def tag_note(note_text, player_id, metadata):
   tagged_note={
      “player_id”: player_id,
      “text”: note_text,
      “timestamp”: metadata[“timestamp”],
      “session_id”: metadata[“session_id”],
      “source_role”: metadata[“source_role”],
      “scout_id”: metadata[“scout_id”],
      “location”: metadata[“location”]
   }
   return tagged_note
Dashboard Synchronization via Publish/Subscribe Engine (Non-Limiting Example)
class DashboardPublisher:
   def_init_(self, broker):
      self.broker=broker
   def publish_update(self, evaluation):
      topic=f“dashboard.region.{evaluation[‘region’]}”
      payload={
         “player_id”: evaluation[“player_id”],
         “status”: evaluation[“status”],
         “timestamp”: evaluation[“timestamp”]
      }
      self.broker.publish(topic, payload)

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

1. A computer-implemented method for capturing time-bounded observations attributed to one or more contributor role identities during a structured live session, comprising
(a) instantiating, by a server computing system, a session record having a session identifier, an associated context attribute set, and a set of contributor role identities associated with the session;
(b) receiving, from each of one or more client devices each associated with a distinct one of said contributor role identities, a respective stream of structured event records, each event record comprising an event payload, a timestamp, the session identifier, and a contributor role identifier;
(c) responsive to receipt of each event record at the server computing system, applying, by a metadata tagging engine, the contributor role identifier and one or more contextual metadata attributes to the event record, and committing the event record to a session-scoped event log in association with the applied attributes, the applying and the committing being performed prior to any rendering of the event record on a viewing client;
(d) responsive to said committing, propagating the event record to a set of subscriber clients via a publish-subscribe propagation pathway, wherein the event record as delivered to each subscriber client is filtered based at least in part on a user role associated with that subscriber client;
(e) detecting termination of the session responsive to at least one of: a manual session-submit input received from one of the client devices, an inactivity interval that exceeds a configured threshold without further event records being received for the session, or a geofencing trigger indicating departure of one of the client devices from a session-associated region; and
(f) responsive to said termination, generating an automated summary of the session by submission of a corpus of the committed event records to a language-model summarization process, and persisting the generated summary in association with the session identifier.

2.-10. (canceled)

11. (canceled)

12. A system for capturing time-bounded observations during a structured live session, the system comprising: at least one processor; and memory storing instructions that, when executed by the at least one processor, cause the system to: instantiate a session record having a session identifier, an associated context attribute set, and a set of contributor role identities; responsive to receipt of each structured event record from a client device, apply a contributor role identifier and one or more contextual metadata attributes to the event record and commit the event record to a session-scoped event log prior to any rendering of the event record on a viewing client; responsive to said commit, propagate the event record to a set of subscriber clients via a publish-subscribe propagation pathway, wherein the event record as delivered to each subscriber client is filtered based at least in part on a user role associated with that subscriber client; detect termination of the session responsive to at least one of a manual session-submit input, an inactivity interval exceeding a configured threshold, or a geofencing trigger; and responsive to said termination, generate an automated summary by submission of a corpus of the committed event records to a language-model summarization process and persist the generated summary in association with the session identifier.

13. A client computing device comprising a display, at least one processor, and memory storing instructions that, when executed, cause the client computing device to: display a session-initiation interface comprising selector controls for at least an organization and a source role; responsive to a selection received via the selector controls, receive from a server computing system a plurality of subject records associated with the selection and concurrently display a plurality of entry regions within a single session view, each entry region bound to a distinct one of the subject records and displaying a completion indicator; receive text input in respective entry regions, automatically save the text input during the session, and transmit to the server computing system structured event records each comprising the text input, a timestamp, a session identifier, a contributor role identifier, and a subject identifier; display a session-submit control operable to terminate the session; and, responsive to termination of the session, receive and display a generated summary for at least one of the subject records in a subject profile view supporting version-tracked edits.

14. The method of claim 1, further comprising: retrieving, responsive to instantiation of the session record, a plurality of subject records associated with the context attribute set; and generating, on at least one of the client devices, a concurrent multi-subject entry interface comprising a plurality of entry regions displayed simultaneously within a single session view, each entry region bound to a distinct one of the subject records, wherein event records of the respective stream are generated from input received in respective entry regions and each includes a subject identifier of the bound subject record.

15. The method of claim 14, wherein the concurrent multi-subject entry interface is generated responsive to a context selection input received through one or more selector controls identifying at least an organization and a source role associated with the session.

16. The method of claim 14, wherein content entered in the entry regions is automatically saved during the session.

17. The method of claim 14, wherein the concurrent multi-subject entry interface displays, for each entry region, a completion indicator reflecting an evaluation completion status of the bound subject record.

18. The method of claim 1, wherein each event record is validated for metadata completeness prior to the committing.

19. The method of claim 14, wherein a single input received in the concurrent multi-subject entry interface is associated with subject identifiers of two or more of the subject records.

20. The method of claim 1, wherein the manual session-submit input is received via a session-submit control displayed within a session interface on the one of the client devices.

21. The method of claim 1, wherein the set of subscriber clients comprises a dashboard client, and further comprising rendering, at the dashboard client, evaluation completion statistics filterable by at least one of contributor role, region, and subject grouping.

22. The method of claim 21, wherein the rendering comprises displaying one or more of completion bars, tier buckets, sentiment graphs, and outstanding-task alerts.

23. The method of claim 1, further comprising rendering the generated summary in a subject profile view, receiving an edit to the generated summary from a user, and logging the edit with a timestamp and a user identifier in a version-controlled repository maintaining a complete revision history and supporting rollback to a prior revision.

24. The method of claim 14, wherein a state of the concurrent multi-subject entry interface is synchronized across two or more client devices in real time via the publish-subscribe propagation pathway, and wherein a real-time update indicator is displayed on at least one of the client devices.

25. The method of claim 1, wherein the contextual metadata attributes applied by the metadata tagging engine comprise geolocation, source role, and device metadata.

26. The method of claim 1, further comprising generating an alert responsive to a determination that an evaluation associated with a subject record is missing or incomplete.

27. The method of claim 1, wherein detecting termination of the session comprises monitoring, independently and concurrently throughout the session, each of: the manual session-submit input, the inactivity interval, and the geofencing trigger, and detecting the termination responsive to whichever occurs first.

28. The method of claim 1, further comprising maintaining a hybrid persistence layer comprising (i) a relational store storing structured event metadata indexed by the session identifier and (ii) a non-relational store storing unstructured event payload, the relational store and the non-relational store being linked by cross-references resolvable by the session identifier, wherein the committing comprises storing structured event metadata of the event record in the relational store and unstructured event payload of the event record in the non-relational store.
